(19) United States
(12) Patent Application Publication
(10) Pub. No.: US 2022/0244165 A1
(43) Pub. Date: Aug. 4, 2022

(54) PARTICULATE MATTER SENSOR

(71) Applicant: ams AG, Premstaetten (AT)

(72) Inventor: Gernot Fasching, Eindhoven (NL)

(21) Appl. No.: 17/617,689

(22) PCT Filed: Jun. 12, 2020
(86) PCT No.: PCT/EP2020/066407

§ 371 Date: Dec. 9, 2021

Related U.S. Application Data
(60) Provisional application No. 62/860,521, filed on Jun. 12, 2019.

(51) Int. Cl. G01N 15/14

(52) U.S. Cl. CPC G01N 15/1434; G01N 2015/1438; G01N 15/1459

(57) ABSTRACT

A particulate matter sensor module is operable based on sensing light scattered by particulate matter. The sensor includes one or more metalenses, which can help achieve a compact design in some implementations.

### FIELD OF THE DISCLOSURE

The present disclosure relates to particulate matter sensors.

### BACKGROUND

Airborne particulate matter can be generated, for example, by different forms of combustion, chemical processes, or mechanical wear. The size of the particles varies over a wide range, with some particles settling quickly in still air, whereas smaller particles may remain suspended for longer periods of time. Exposure to particulate matter can be harmful to human health. Further, some particulates act as abrasives or contaminates, and can interfere with the performance of equipment.

Some techniques for measuring the presence, amount and/or size of particulate matter in the air rely on optical techniques in which particles are illuminated with an optical signal and light scattered by the particles is detected.

### SUMMARY

The present disclosure describes particulate matter sensor modules that operate based on sensing light scattered by the particulate matter. In applications such as smartphones and other portable computing devices, space is at a premium. In some instances, to help achieve compact particulate matter sensor modules, one or more metalenses are integrated into the particulate matter sensor.

In one aspect, for example, the present disclosure describes an apparatus that includes a particle-light interaction chamber, a light detector, and a light source operable to produce light, wherein the light travels along a first path that intersects the particle-light interaction chamber. A fluid flow conduit intersecting the particle-light interaction chamber. The apparatus further includes a light trap. The apparatus is operable such that at least some of the light entering the particle-light interaction chamber is scattered by interaction with particles along a second path toward the light detector, and wherein at least some of the light traveling along the first path and passing through the particle-light interaction chamber without interaction with the particles in the particle-light interaction chamber travels along a third path to the light trap. The apparatus includes a metalens disposed so that light traveling along the first path passes through the metalens.

Some implementations include one or more of the following features. The apparatus can include a reflective surface operable to redirect light produced by the light source toward the particle-light interaction chamber, wherein the metalens is disposed along the first path between the light source and the reflective surface. In some instances, the apparatus further includes an aperture disposed along the first path between the light source and the reflective surface.

In some cases, the apparatus includes a reflective surface operable to redirect light produced by the light source toward the particle-light interaction chamber, wherein the metalens is disposed along the first path between the reflective surface and the particle-light interaction chamber. In some instances, the apparatus further includes an aperture disposed along the first path between the metalens and the particle-light interaction chamber.

In another aspect, the present disclosure describes an apparatus that includes a particle-light interaction chamber, a light detector, and a light source operable to produce light, wherein the light travels along a first path that intersects the particle-light interaction chamber. A fluid flow conduit intersecting the particle-light interaction chamber. The apparatus further includes a light trap. The apparatus is operable such that at least some of the light entering the particle-light interaction chamber is scattered by interaction with particles along a second path toward the light detector, and wherein at least some of the light traveling along the first path and passing through the particle-light interaction chamber without interaction with the particles in the particle-light interaction chamber travels along a third path to the light trap. The apparatus further includes a metalens disposed so that light traveling along the third path passes through the metalens.

Some implementations include one or more of the following features, For example, in some implementations, the apparatus further includes an aperture disposed between the metalens an entry of the light trap. The aperture can have a width, for example, in a range of 10-100 μm.

In some instances, the apparatus includes first and second apertures disposed along the third path between the particle-light interaction chamber and an entry of the light trap, wherein the metalens is disposed between the first and second apertures. In some cases, the first aperture is closer to the particle-light interaction chamber than is the second aperture, and the metalens is closer to the first aperture than to the second aperture.

In some implementations, the metalens is integrated with the light source.

In some implementations, the metalens is formed directly on top of the light source by semiconductor processing techniques.

In some implementations, the light source is composed of a single VCSEL. In some implementations, the metalens comprises micropillars. Some implementations include more than one metalens.

The present disclosure also describes a mobile computing device (e.g., a smartphone) that includes a particulate matter sensor system including a particulate matter sensor module, an application executable on the mobile computing device and operable to conduct air quality testing, and a display screen operable to display a test result of the application.

Other aspects, features and advantages will be readily apparent from the following detailed description, the accompanying drawings, and the claims.

### BRIEF DESCRIPTION OF THE DRAWINGS

FIG. 1 illustrates a schematic diagram showing a first example of a particulate matter sensor module.

FIG. 2 illustrates a schematic diagram showing a second example of a particulate matter sensor module.

FIG. 3 illustrates a schematic diagram showing a third example of a particulate matter sensor module.

FIG. 4 illustrates a schematic diagram showing a fourth example of a particulate matter sensor module.

FIG. 5 illustrates an example of a host device in which the sensor modules can be integrated.

### DETAILED DESCRIPTION

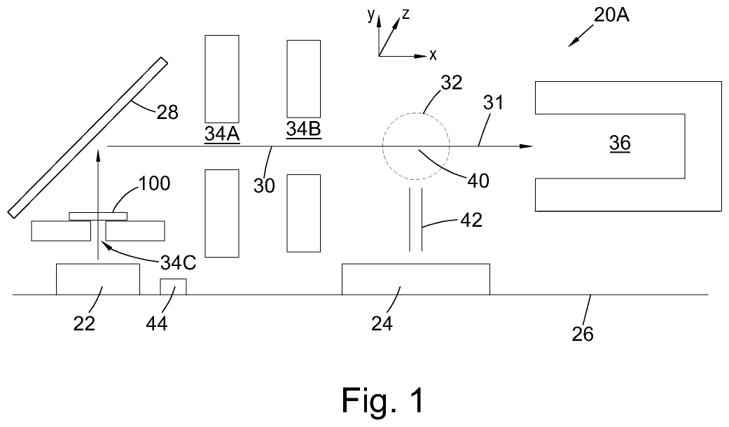

As shown in FIG. 1, a particulate matter sensor module 20A includes a light source 22 (e.g., one or more vertical cavity surface emitting lasers (VCSELs); light emitting diodes (LEDs); or laser diodes) operable to emit light toward a reflective surface 28 (e.g., a mirror), which redirects the emitted light along a first path 30 through one or more light apertures 34A, 34B such that the light path 30 passes through a particle-light interaction chamber 40. Fluid (e.g., an aerosol) is pumped through a fluid flow conduit 32, which can be substantially perpendicular to the light path 30. Thus, in the illustrated example, the light path 30 is in the x-direction, and the fluid flow conduit 32 is in the z-direction. As a fluid flows through the conduit 32, the light beam interacts, in the particle-light interaction chamber 40, with particulate matter in the fluid. The interaction scatters some of the light along a second path toward a light detector 24 (e.g., a photodiode) operable to detect the scattered light. In some implementations, a light pipe or other waveguide 42 can be provided to guide the scattered light toward the light detector 24 and to reduce the effective distance from the particle-light interaction chamber 40 to the detector 24. Light that does not interact with the particular matter continues to travel along a third path 31 into a light trap chamber 36 to prevent such light from being reflected back toward the detector 24.

The detector 24 can be implemented, for example, as an optical photosensor that is operable to measure the signal of a single particle. In such instances, the pulse height is proportional to particle size, and the pulse count rate corresponds to the number of detected particles. The concentration can be derived, for example, from the number of detected particles, if the amount of the analyzed volume is known (e.g., air flow rate, measurement time). The mass can be calculated based on an assumed refractive index and density. In other implementations, the detector 24 is implemented as a photometer or nephelometer. The detector 24 can be integrated, for example, into a semiconductor chip that also may include electronics for reading, amplifying and processing the signals. In some cases, the processing circuitry may reside in a separate chip. The light source 22 and detector 24 can be mounted on, and electrically connected to, a substrate 26 (e.g., a printed circuit board).

In some implementations, a second light detector 44 can be mounted on the substrate and can be used to monitor the light power emitted from the light source 22. The second detector 44 can be placed, for example, next to the light source or below an aperture in the light trap chamber 36.

In applications such as smartphones and other portable computing devices (e.g., laptop computers, tablet computers, wearables, personal digital assistants (PDAs)), space is at a premium. To help achieve compact particulate matter sensor modules one or more lenses can be integrated into the particulate matter sensor. In particular, one or more metalenses can be integrated into the particulate matter sensor modules. Metalenses can be composed of micropillars which can be etched, for example, into an amorphous silicon layer deposited on a glass substrate. In some cases, the thickness of the amorphous silicon layer is on the order of about 500 nm, and the glass substrate has a thickness on the order of about 100 to 400 um. Thus, the overall thickness of the metalens is still thin enough to be integrated in very small sensors. Particular examples of implementations that include a metalens are described in the following paragraphs.

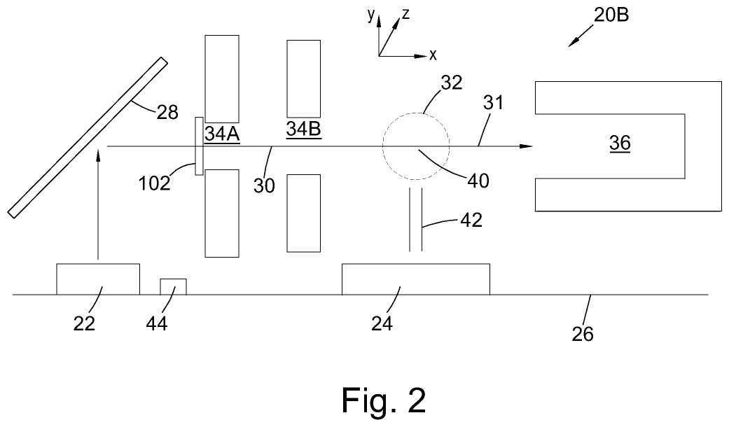

In some implementations, a metalens is disposed in the beam path between the light source 22 and the particle-light interaction chamber 40 to help collimate the beam (i.e., reduce the divergence angle). The design angle of the metalens preferably should result in the light still covering the substantially the entire volume of the particle-light interaction chamber 40. Thus, the design angle of the metalens depends on the position where the metalens is placed. For example, in general, placing the metalens closer to the light source 22 may require a larger angle to cover a given same volume of the particle-light interaction chamber 40. As shown in the example of FIG. 1, a metalens 100 is disposed along the light path 30 between the light source 22 and the reflective surface 28 (e.g., just after an aperture 34C). On the other hand, in the particulate matter sensor module 20B of FIG. 2, a metalens 102 is disposed along the light path 30 between the reflective surface 28 and the particle-light interaction chamber 40, for example, at the entrance to the aperture 34A. Placing the metalens in the position as shown in FIG. 1 can be advantageous in some cases because the placement and alignment can be handled more easily from the top, in contrast to having to place the metalens on the vertically-oriented aperture 34A as shown in FIG. 2.

The implementations of FIGS. 1 and 2 can provide various advantages in some implementations. For example, there is little or no energy loss due to beam shaping using a metalens. Thus, instead of using only a relatively small percentage of the emitted light for particle detection (e.g., only 10-20%), the sensor 20A or 20B can use a much larger percentage of the emitted light for particle detection (e.g., 80-90% in some cases. An increase in energy efficiency can be important for smartphone and other applications. As a result, instead of using multiple VCSELs as the light source 22, in some instances, a single VCSEL can be used as the light source 22. This reduces chip size and design and allows better thermal management. Further, incorporating the metalens 100 or 102 can help reduce the amount of stray light in the sensor. Also, the metalens 100 or 102 can be used to shape the light intensity profile in a way that it is more homogeneous across the interaction volume.

In some implementations, the metalens can be integrated with the light source 22. In some implementations, the metalens can be disposed directly on top of the light source 22. For example, the light source 22 can be produced using semiconductor processing techniques, and the metalens can be formed directly on top of the light source 22 during semiconductor processing. In some implementations, the metalens can be produced as layers of material on top of the light source, and the layers can then be processed to form a metalens. For example, light source 22 can be a VCSEL which is produced by semiconductor processing as a VCSEL stack, and layers of material can be added to the VCSEL stack and then processed to form a metalens. A metalens that is integrated with the light source 22 can provide various advantages in some implementations. For example, a metalens that is integrated with the light source 22 can lower the overall cost of producing the sensor module. Furthermore, integrating the metalens with the light source 22 can improve the alignment precision between the light source 22 and the metalens, for example because there is no need to align the metalens during assembly of the sensor module. A metalens that is integrated with the light source 22 can also further improve the energy efficiency of the sensor module by further increasing the amount of light that is used for particle detection. Also, a metalens that is integrated with the light source 22 can further reduce the overall size of the sensor module which is important for smartphone and other applications. A metalens that is integrated with the light source 22 can also reduce the dependency of the amount of light that is scattered by a particle on the distance between the particle and the detector 24, further shaping the light intensity profile in a way that it is more homogeneous across the interaction volume and so minimizing the particle diameter detection error.

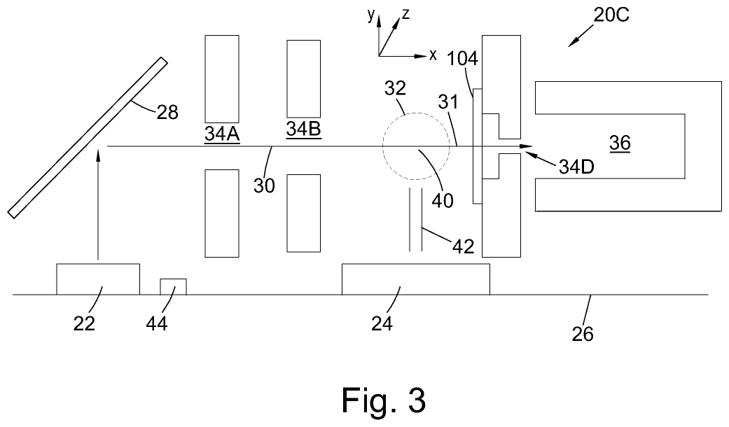

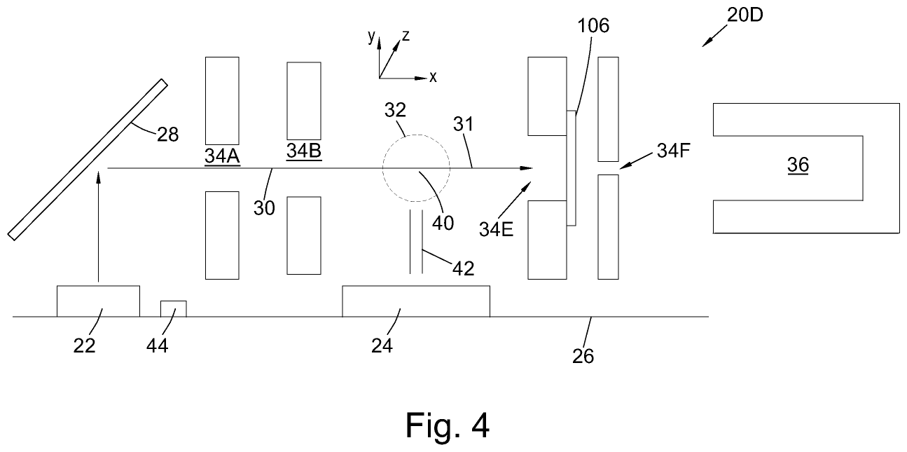

In many applications, most of the light entering the particle-light interaction chamber 40 passes through to the light trap 36 because the amount of light scattered by particles in the chamber 40 is extremely small. Thus, the efficiency of the light trap 36 is important and preferably should prevent as much light as possible from being reflected back toward the detector 24. FIGS. 3 and 4 illustrate designs that can help address this issue.

As shown in FIG. 3, for example, a particulate matter sensor module 20C includes a metalens 104 disposed in the light path 31 between the exit of the particle-light interaction chamber 40 and the entry of the light trap 36. The metalens 104 helps focus the light passing through the chamber 40 through a small aperture 34D provided in the light path 31 just after the metalens 104. The combination of the metalens 104 and the small aperture 34D can help reduce the amount of light that is reflected back onto the light detector 24. In some instances, the aperture 34D takes the form of a slit having a width in the range of 10-100 μm.

As shown in FIG. 4, a particulate matter sensor module 20D includes first and second apertures 34E, 34F disposed along the light path 31 between the exit of the particle-light interaction chamber 40 and the entry of the light trap 36. The first aperture 34A, which is closer to the chamber 40, is larger than the second aperture 34F. A metalens 106 is disposed just behind the first aperture 34E. The metalens 106 helps focus the light passing through the chamber 40 through the small aperture 34F. In some instances, the aperture 34F takes the form of a slit having a width in the range of 10-100 μm. This configuration also can help reduce the amount of light that is reflected back onto the light detector 24.

Some implementations can include a respective metalens at more than one position along the light path. For example, a first metalens may be disposed as shown in FIG. 1 or 2, and a second metalens may be disposed as shown in FIG. 3 or 4.

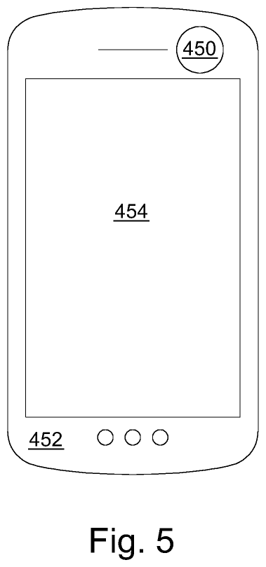

As shown in FIG. 5, a particulate matter sensor system 450 including a particulate matter sensor module (e.g., module 20A, 20B. 20C or 20D) can be incorporated into a mobile or handheld computing device 452, such as a smartphone (as shown), a tablet, or a wearable computing device. The particulate matter sensor system 450 can be operable by a user, e.g., under control of an application executing on the mobile computing device 452, to conduct air quality testing. A test result can be displayed on a display screen 454 of the mobile computing device 452, e.g., to provide substantially immediate feedback to the user about the quality of the air in the user's environment.

The particulate matter sensor systems described here can also be incorporated into other devices, such as air purifiers or air conditioning units; or used for other applications such as automotive applications or industrial applications.

Various modifications will be readily apparent and can be made to the foregoing examples. Features described in connection with different embodiments may be incorporated into the same implementation in some cases, and various features described in connection with the foregoing examples may be omitted from some implementations. Thus, other implementations are within the scope of the claims.

1. An apparatus comprising:
a particle-light interaction chamber;
a light detector;
a light source operable to produce light, wherein the light travels along a first path that intersects the particle-light interaction chamber;
a fluid flow conduit intersecting the particle-light interaction chamber; and
a light trap;
wherein the apparatus is operable such that at least some of the light entering the particle-light interaction chamber is scattered by interaction with particles along a second path toward the light detector, and wherein at least some of the light traveling along the first path and passing through the particle-light interaction chamber without interaction with the particles in the particle-light interaction chamber travels along a third path to the light trap,
wherein the apparatus further includes a metalens disposed so that light traveling along the first path passes through the metalens.

2. The apparatus of claim 1 further including a reflective surface operable to redirect light produced by the light source toward the particle-light interaction chamber, wherein the metalens is disposed along the first path between the light source and the reflective surface.

3. The apparatus of claim 2 further including an aperture disposed along the first path between the light source and the reflective surface.

4. The apparatus of claim 1 further including a reflective surface operable to redirect light produced by the light source toward the particle-light interaction chamber, wherein the metalens is disposed along the first path between the reflective surface and the particle-light interaction chamber.

5. The apparatus of claim 4 further including an aperture disposed along the first path between the metalens and the particle-light interaction chamber.

6. The apparatus of claim 1 wherein the metalens is integrated with the light source.

7. The apparatus of claim 1 wherein the metalens is formed directly on top of the light source by semiconductor processing techniques.

8. The apparatus of claim 1 wherein the light source is composed of a single VCSEL.

9. An apparatus comprising:
a particle-light interaction chamber;
a light detector;
a light source operable to produce light, wherein the light travels along a first path that intersects the particle-light interaction chamber;
a fluid flow conduit intersecting the particle-light interaction chamber; and
a light trap;
wherein the apparatus is operable such that at least some of the light entering the particle-light interaction chamber is scattered by interaction with particles along a second path toward the light detector, and wherein at least some of the light traveling along the first path and passing through the particle-light interaction chamber without interaction with the particles in the particle-light interaction chamber travels along a third path to the light trap,
wherein the apparatus further includes a metalens disposed so that light traveling along the third path passes through the metalens.

10. The apparatus of claim 9 further including an aperture disposed between the metalens and an entry of the light trap.

11. The apparatus of claim 10 wherein the aperture has a width in a range of 10-100 μm.

12. The apparatus of claim 9 including first and second apertures disposed along the third path between the particle-light interaction chamber and an entry of the light trap, wherein the metalens is disposed between the first and second apertures.

13. The apparatus of claim 12 wherein the first aperture is closer to the particle-light interaction chamber than is the second aperture, and wherein the metalens is closer to the first aperture than to the second aperture.

14. The apparatus of claim 12 wherein the aperture has a width in a range of 10-100 μm.

15. The apparatus of claim 1 wherein the metalens comprises micropillars.

16. A mobile computing device comprising:
a particulate matter sensor system including a particulate matter sensor module the apparatus according to claim 1;
an application executable on the mobile computing device and operable to conduct air quality testing; and
a display screen operable to display a test result of the application.

17. A mobile computing device comprising:
a particulate matter sensor system including the apparatus according to claim 9;
an application executable on the mobile computing device and operable to conduct air quality testing; and
a display screen operable to display a test result of the application.
